(19) United States
(12) Patent Application Publication
(10) Pub. No.: US 2026/0238793 A1
(43) Pub. Date: Aug. 13, 2026

(54) CROSS-COMPONENT PREDICTION TOOLS IN VIDEO CODING

(71) Applicant: DOLBY LABORATORIES LICENSING CORPORATION

(72) Inventors: Jeeva Raj ARUMUGAM, Rasipuram (IN); Ashwin NATESAN, Bangalore (IN); Vaibhav Pandurang VALVAIKER, Bangalore (IN); Jay Nitin SHINGALA, Bangalore (IN); Fangjun PU, Sunnyvale, CA (US); Taoran LU, Santa Clara, CA (US); Peng YIN, Ithaca, NY (US)

(73) Assignee: DOLBY LABORATORIES LICENSING CORPORATION, (US)

(21) Appl. No.: 19/474,645

(22) PCT Filed: Apr. 11, 2024
(86) PCT No.: PCT/US2024/024143

§ 371 Date: Oct. 10, 2025

(30) Foreign Application Priority Data
Apr. 12, 2023 (IN) 202311027178
Jun. 7, 2023 (IN) 202311038996

(51) Int. Cl. H04N 19/136; H04N 19/182; H04N 19/186; H04N 19/70

(52) U.S. Cl. CPC H04N 19/136; H04N 19/182; H04N 19/186; H04N 19/70

(57) ABSTRACT

Methods and systems are described for video coding and decoding using cross-component prediction tools. The proposed methods include: inter-luma based modeling for chroma, cross component residue prediction, and convolutional cross-component intra prediction.

### CROSS-REFERENCE TO RELATED APPLICATIONS

This application claims the benefit of priority from Indian Provisional Patent Application Ser. No. 202311027178, filed on 12 Apr. 2023, and Indian Provisional Patent Application Ser. No. 202311038996, filed on 7 Jun. 2023, each of which is incorporated by reference herein in its entirety.

### TECHNOLOGY

The present document relates generally to images and video coding. More particularly, an embodiment of the present invention relates to applications of cross-component prediction tools in video coding.

### BACKGROUND

In 2020, the MPEG group in the International Standardization Organization (ISO), jointly with the International Telecommunications Union (ITU), released the first version of the Versatile Video Coding Standard (VVC), also known as H.266 (Ref. [1]). More recently, the same group has been working on the development of the next generation coding standard that provides improved coding performance over existing video coding technologies. As part of this investigation, new coding techniques are also examined.

As appreciated by the inventors here, improved techniques for applying cross-component prediction tools in image and video coding are desired, and they are described herein. As used herein, the term “cross-component prediction” denotes predicting luma an/or chroma pixel values using chroma and luma chroma respectively. That is, luma prediction includes chroma values and chroma prediction includes luma values.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example of the locations of pixel samples used in the cross-component lineal model (CCLM);

FIG. 2 depicts an example of the spatial weights of a convolution filter used in CCLM;

FIG. 3 depicts an example of a reference area (with padding) being used in CCLM;

FIG. 4 depicts an example of Sobel-based filters used in a gradient linear model (GLM);

FIG. 5 depicts an example of luma-based modeling for chroma for Intra code units (CUs) according to prior art;

FIG. 6 depicts an example of luma-based modeling for chroma for Inter CUs according to an embodiment of this invention;

FIG. 7 depicts an example process of data flow for Inter-LMC according to an embodiment of this invention;

FIG. 8A depicts an example process for a data flow for cross-component residue modeling in an encoder according to an embodiment of this invention;

FIG. 8B depicts an example process for cross-component residue modeling in a decoder according to an embodiment of this invention; and

FIG. 9 depicts an example of a reference area used for deriving implicitly the cross-component residue modeling (CCRM) model parameters according to an embodiment of this invention.

### DESCRIPTION OF EXAMPLE EMBODIMENTS

Example embodiments that relate to applying cross-component prediction tools in video coding are described herein. In the following description, for the purposes of explanation, numerous specific details are set forth in order to provide a thorough understanding of the various embodiments of the present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to applying cross-component prediction tools in image and video coding for intra or inter prediction. The proposed methods include: 1) inter luma based modeling for chroma (inter luma and intra luma-chroma for Inter coding units (CUs)); 2) cross component residue prediction; 3) convolutional cross-component intra prediction.

### Cross-Component Prediction in Video Coding

In the enhanced compression model (ECM) software implementation, e.g., ECM 7 or later (Ref. [2]), the cross-component linear model (CCLM) prediction mode, the convolutional cross-component intra prediction model (CCCM) mode, and the gradient linear model (GLM) mode predict the chroma using the modeling of luma reconstruction pixels. A quick overview of these prediction modes is given next.

### CCLM: Cross-Component Linear Model Prediction Mode

In VVC (Ref.[1]), the CCLM mode predicts chroma samples based on the reconstructed luma samples of the same coding unit (CU) by using a linear model as follows:

$${pred}_{C} ( i , j ) = α \cdot {rec}_{L}^{′} ( i , j ) + β , \qquad ( 1 )$$

where pred_{C}(i,j) represents the predicted chroma samples in a CU, rec′_{L}(i, j) represents the downsampled reconstructed luma samples of the same CU, and α and β denote model parameters.

It has three modes: linear model (LM) mode (using both above and left neighbouring samples), LM-A mode (using only the above neighboring samples), and LM-L mode (using only the left neighboring samples).

The α and β parameters are estimated as follows. FIG. 1 shows an example of the location of the left and above samples involved in the CCLM mode compared to the samples of the current block. Groups of four neighbouring luma samples at the selected positions are down-sampled and compared four times to find two larger values: x⁰_{A} and x¹_{A}, and two smaller values: x⁰_{B} and x¹_{B}. Their corresponding chroma sample values (Rec_{C}) are denoted as y⁰_{A}, y¹_{A}, y¹_{B} and y¹_{B}. Then Xₐ, X_{b}, Yₐ, and Y_{b} are derived as:

$${X}_{a} = ( {x}_{A}^{0} + {x}_{A}^{1} + 1 ) ≫ 1 ; \qquad ( 2 )$$

$${X}_{b} = ( {x}_{B}^{0} + {x}_{B}^{1} + 1 ) ≫ 1 ;$$

$${Y}_{a} = ( {y}_{A}^{0} + {y}_{A}^{1} + 1 ) ≫ 1 ;$$

$${Y}_{b} = ( {y}_{B}^{0} + {y}_{B}^{1} + 1 ) ≫ 1 ,$$

where x>>n denotes a binary right-shift of x by n positions, or a division of x by 2. Finally, the linear model parameters a and lop are obtained according to the following equations:

$$α = \frac{{Y}_{a} - {Y}_{b}}{{X}_{a} - {X}_{b}} , \qquad ( 3 )$$

$$β = {Y}_{b} - α \cdot {X}_{b} .$$

### CCCM: Convolutional Cross-Component Intra Prediction Model

CCCM is like CCLM but is using a convolutional filter, where a 7-tap filter consist of a 5-tap plus sign shape spatial component, a nonlinear term (P), and a bias term (B) as:

$$predChromaVal = {c}_{0} C + {c}_{1} N + {c}_{2} S + {c}_{3} E + {c}_{4} W + {c}_{5} P + {c}_{6} B , \qquad ( 4 )$$

where cᵢ, for i=0, 1, . . . , 6, are filter coefficients, B is the bias term, and P is the non-linear term computed as

$$P = ( C * C + midVal ) ≫ bitDepth ,$$

where bitDepth denotes the bit depth of the luma component and midVal=2^{(bitDepth-1)}.

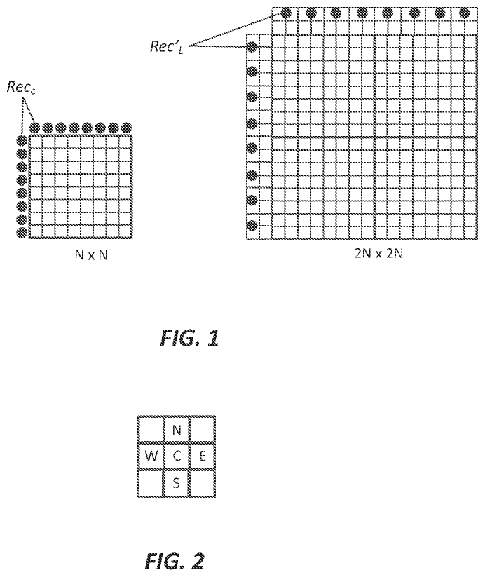

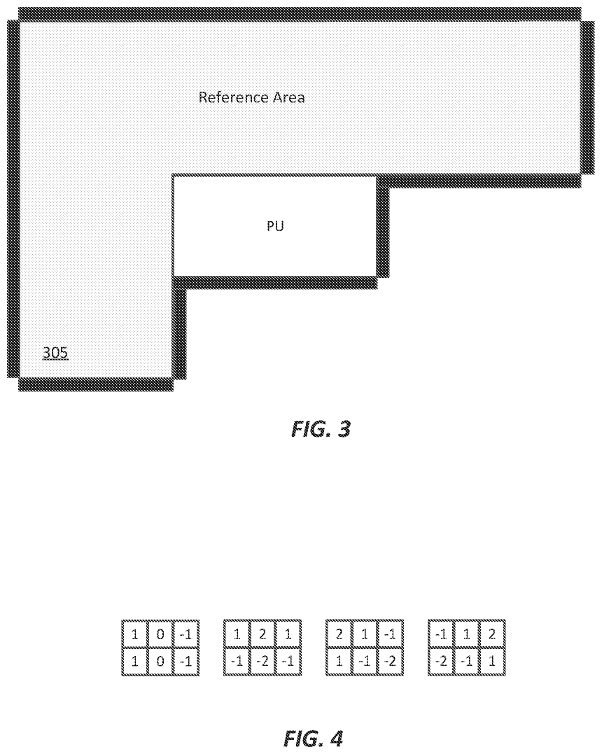

The input to the spatial 5-tap component of the filter consists of a center (C) luma sample which is collocated with the chroma sample to be predicted, and its above/north (N), below/south (S), left/west (W) and right/east (E) neighbors, as illustrated in FIG. 2. The bias term B represents a scalar offset between the input and output and typically is set to the middle chroma value (e.g., 512 for 10-bit content). The filter coefficients cᵢ are calculated by minimising a mean-square error (MSE) between predicted and reconstructed chroma samples in a reference area (Ref. [2]). For example, as shown in FIG. 3, the predicted unit (PU) is surrounded by a reference area (305) which consists of n (say, n=6) lines or columns of chroma samples above and left of the PU. The reference area extends one PU-width to the right and one PU-height below the PU boundaries. The reference area is adjusted to include only available samples. The extensions to the reference area shown in black (by one row or one column of pixels) are needed to support the “side samples” of the cross-shaped spatial filter shown in FIG. 2 and are padded when the filter is applied in unavailable areas.

### GLM: Gradient Linear Model

GLM utilizes luma sample gradients G to derive the linear model:

$$C = α \cdot G + β . \qquad ( 5 )$$

Four 3×2 gradient filters are enabled for GLM, as illustrated in FIG. 4.

As discussed next, in example embodiments of this invention, several new cross-component prediction tools are proposed.

### Inter Luma Based Modeling for Chroma (Inter Luma and Intra LM Chroma for Inter CUs)

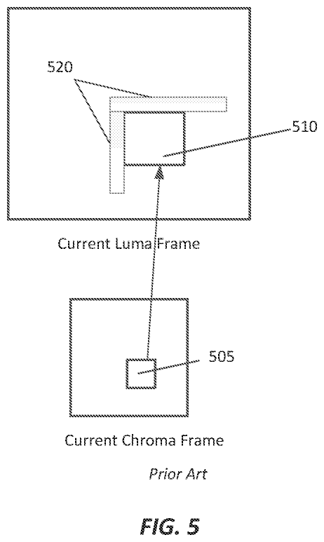

In past conventional codecs, for inter-coding tools, luma and chroma share the same or scaled motion vectors (MVs) based on the luma and chroma sampling formats (e.g., 4:2:0, 4:4:4, and the like). In example embodiments of this disclosure, it is proposed to break these conventional rules. For example, luma uses the MV for inter-prediction, but chroma uses the luma-dependent cross-component prediction tools. The basic idea is that for specific content, for inter-coding units, chroma (505) can be predicted better using the reconstructed luma (510, 520) with those cross-component intra chroma tools, such as CCLM, CCCM, GLM, and the like. There are several cross-component prediction tools available in ECM [2] for Intra coded CUs, where, as shown in FIG. 5, chroma (505) is predicted using the luma reconstructed samples of Intra CUs (510) using modeling parameters derived through techniques like CCLM, CCCM, and GLM.

There are several contents where Inter CUs get coded with more residual bits for chroma (e.g., high texture regions) and cross-component prediction can help further to improve coding gains through improved chroma prediction. Example embodiments presented herein propose applying cross-component prediction for Inter CUs to improve compression efficiency.

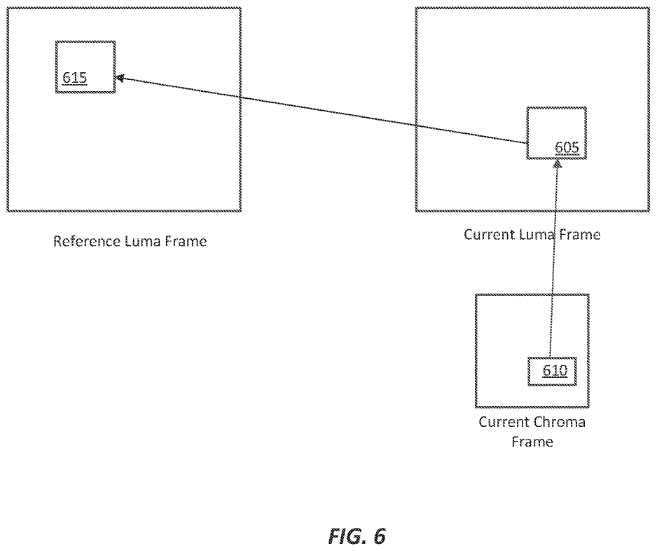

As shown in FIG. 6, the current luma block (605) is predicted using inter prediction and is reconstructed like any Inter CUs, whereas the chroma blocks (610) are predicted using the current luma reconstructed samples (605) with appropriate modeling parameter derived using techniques like CCLM, CCCM, GLM, or any other similar modeling techniques. This coding tool will be referred as Inter-LMC (Luma based modeling for chroma for Inter CUs).

In another embodiment, instead of using the neighboring luma and chroma reconstructed pixels, one can use the inter-mode-derived luma and chroma prediction samples of the current CU for deriving either one of the CCLM and CCCM models, and apply the model on the current CU's luma reconstruction to derive the Inter-LMC predictor.

In another embodiment, instead of always using the neighboring luma and chroma reconstructed pixels, one can use either the inter-mode-derived luma and chroma prediction samples of the current CU or the neighboring luma and chroma reconstructed pixels for deriving either one of the CCLM and CCCM models, and then signal the choice via a new syntax flag.

In another embodiment, the models for either CCLM or CCCM are modified to use either the neighboring luma and chroma reconstructed pixels or the inter-mode-derived luma and chroma prediction samples of the current CU based on CU size. The model parameters can be derived using either low-level decomposition (LLD) or Gaussian decomposition.

In another embodiment, the models for either CCLM or CCCM are modified to use both the neighboring luma and chroma reconstructed pixels and the inter-mode-derived luma and chroma prediction samples of the current CU. The model parameters can be derived using either low-level decomposition (LLD) or Gaussian decomposition.

In another embodiment, the chroma prediction may be derived using a fusion of the CCLM and CCCM models. The fusion weight (w) can be fixed (say, w=0.5) or w can be derived via a template matching process. For example, if fusion is expressed as:

$${T}_{Ref} = w * {T}_{Inter} + ( 1 - w ) * {T}_{LMC} , \qquad ( 6 )$$

the minimization model to derive w can be expressed as:

$${{min}_{w} ( {T}_{Ref} - w * {T}_{Inter} - ( 1 - w ) * {T}_{LMC} )}^{2} ,$$

where,
T_{Ref} denotes chroma predicted pixels using a reference template region, i.e., (width)×4 and 4×(height) chroma reconstruction strips bordering the current CU;
Tᵢₙₜₑᵣ denotes chroma predicted pixels derived using inter prediction for the reference template region; and
T_{LMC} denotes chroma predicted pixels derived using LMC prediction for the reference template region.

In another embodiment, the encoder may choose among a variety of chroma prediction modes (as described earlier) and signal the selected choice via appropriate syntax parameters. An example of such syntax is depicted in Table 1.

TABLE 1
Example syntax for Inter-LMC

| | Descriptor |
|---|---|
| coding_unit( x0, y0, cbWidth, cbHeight, cqtDepth, treeType, modeType ) { | |
| ... | |
| } else if( treeType != DUAL_TREE_CHROMA ) { /* MODE_INTER or | |
| MODE_IBC */ | |
| ... | |
| if(skip and !IBC and !GPM && !CIIP && merge) { | |
| inter_lmc_flag | ae(v) |
| if( inter_lmc_flag ) { | |
| inter_lmc_mode_idx | ae(v) |
| cccm_flag | ae(v) |
| } | |
| } | |
| ... | |
| .... | |
| } | |

inter_lmc_flag equal to 1 indicates Inter-LMC is used. inter_lmc_flag equal to 0 indicates Inter-LMC is not used.
inter_lmc_mode_idx specifies the index of the selected Inter-LMC mode (e.g., choosing between LM_CHROMA_IDX and MMLM_CHROMA_IDX).
cccm_flag equal to 1 indicates CCCM is used. cccm_flag equal to 0 indicates CCLM is used.

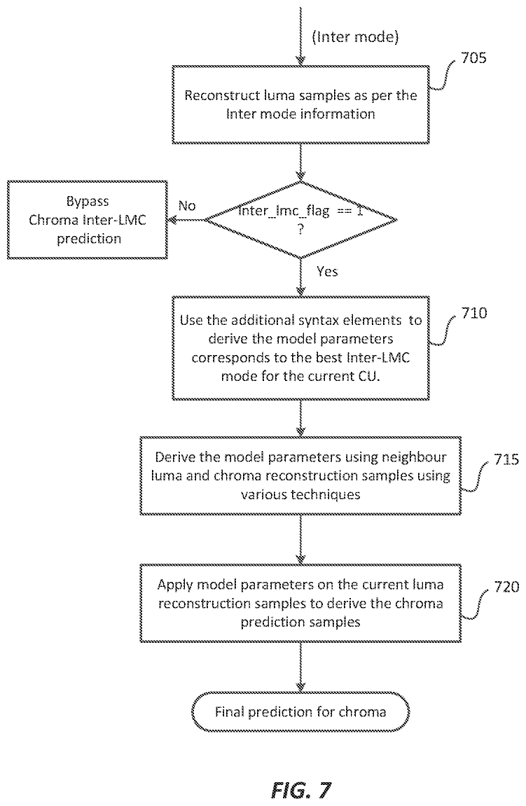

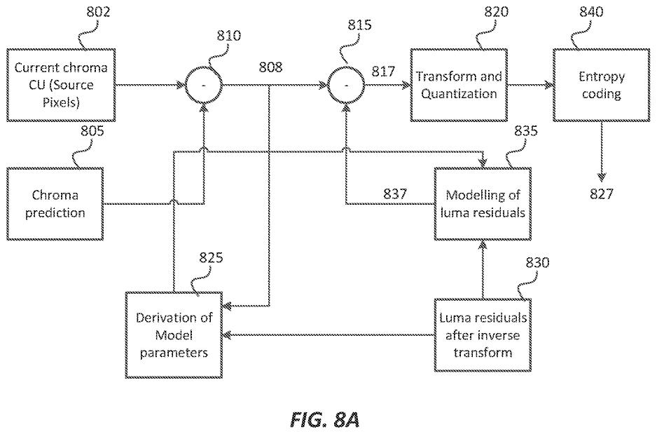

FIG. 7 depicts an example data flow to derive the chroma prediction for Inter-LMC modes. As depicted in FIG. 7, a decoder reconstructs pixels based on inter-coding syntax parameters (705). If inter_lmc_flag==1, then a decoder uses additional syntax elements (like inter_lmc_mode_idx and cccm_flag) to derive additional parameters for modeling chroma reconstruction (710, 715). The derived model parameters are then applied to derive reconstructed chroma samples (720).

In an experiment, as shown in Table 2, it was found that disabling subblock division for Inter-LMC can improve coding efficiency, thus, in some embodiments, it may be preferred to not use subblock division for Inter-LMC. For example, under class F, without block subdivision the compression gain on BD-Y is −0.18% versus −0.01% with subblock division. In Table 2, Class D and Class F refer to the classes of video test sequences being used in JVET.

TABLE 2
JVET SDR-CTC LDB results of Inter-LMC with and without subblock

| | Class D | | | Class F | | |
|---|---|---|---|---|---|---|
| Low Delay B | BD-Y | BD-U | BD-V | BD-Y | BD-U | BD-V |
| Inter-LMC with subblock division | 0.09% | −3.32% | −3.47% | −0.01% | −4.76% | −4.35% |
| Inter-LMC without subblock division | 0.05% | −3.57% | −3.47% | −0.18% | −5.29% | −5.56% |

### Cross Component Residue Modeling (CCRM) and Cross-Component Residue Prediction (CCRP)

This is an intra prediction tool and the motivation is to get better chroma prediction using luma residual modeling.
a. Reconstruction will have low and high frequency signals, where traditional intra prediction may help to predict the low frequency signal better.
b. The high frequency part can be predicted using the cross-component residual model

The method can be described as follows:

Consider PredL and ReconL are the predicted and reconstructed luma data. PredC is the predicted data for chroma corresponding to the luma intra pred mode, then:

$$PredCfinal = PredC + ( alpha * ( Luma Residuals ) ) , \qquad ( 7 )$$

where alpha values (the modeling parameters) are derived in the decoder based on modeling using neighbor residual properties of luma and chroma. Alternatively, the modeling parameters may be derived in the encoder and can be signaled to the decoder via appropriate syntax parameters. In equation (7), using luma residuals instead of luma pixel values allows for improved prediction because the high frequency part of the chroma signal might be better predicted as the modeling improves using only a high-frequency residual signal.

In an embodiment, the alpha parameter can be computed based on modeling using neighboring luma and chroma residue values. Assume Res_{C} represents the chroma residue value and Res′_{L} represents the down-sampled luma residue value. Then alpha (α) can be derived based on linear minimum squared error estimation, using causal residue samples around the current blocks as follows:

$$α = \frac{N * {\sum }_{1}^{N} {Res}_{C} [ i ] \times {Res}_{L}^{′} [ i ] - {\sum }_{1}^{N} {Res}_{C} [ i ] \times {\sum }_{1}^{N} {Res}_{L}^{′} [ i ]}{N \times {\sum }_{1}^{N} {Res}_{L}^{′} [ i ] \times {Res}_{L}^{′} [ i ] - {( {\sum }_{1}^{N} {Res}_{L}^{′} [ i ] )}^{2}} , \qquad ( 8 )$$

where Res_{C} and Res′_{L} are chroma residue samples and down-sampled luma residue samples around the current block, and N denotes the total number of neighboring samples.

In another embodiment, alpha can be explicitly signaled from an encoder to the decoder. For example, one may allow a set of alpha values, e.g.: [0, ±⅛, ±¼, ±½, ±1]. Then one may use a syntax parameter, say, alpha_idx, to signal which alpha value is selected within this pre-specified table along with a sign flag for each chroma component.

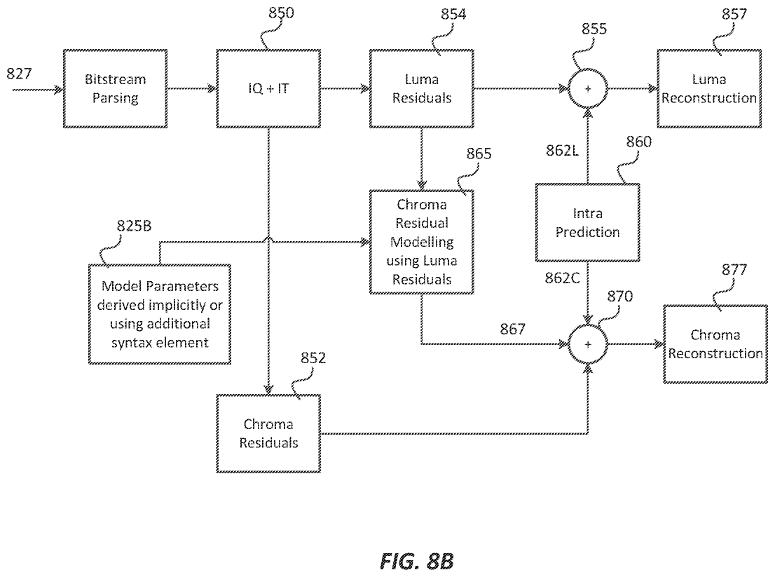

FIG. 8A depicts an example of the encoder-side data flow for deciding modeling CCRM/CCPM parameters and how the chroma residuals are derived using cross-component residual modeling. The process uses the original (incoming) uncompressed chroma values (802), predicted chroma values (805) and predicted luma residual values (830), as they are expected to be received in the decoder (e.g., after inverse quantization and the inverse transform, which are not shown). Given the input chroma values (802) and predicted chroma values (805), subtractor 810 generates residual chroma values (808), which, in combination with the predicted luma residual values (830) are used to derive the CCRM/CCPM model parameters (e.g., alphas). The output of “modeling of luma residuals” (835), e.g., alpha*Luma Residuals, (837), is further subtracted (in 815) from the chroma residual (808) and the final chroma residual output (817) (together with corresponding luma residuals, which are not shown) is passed to transform and quantization (820) and entropy coding (840) to generate an output bitstream (827).

In an embodiment, in unit “derivation of model parameters” (825), modeling parameters for CCRM/CCRP can be derived using neighbor residual properties of luma and chroma. These parameters may be regenerated in the decoder or, alternatively, they can be signaled to the decoder via proper syntax parameters by considering the bits vs distortion trade-offs.

FIG. 8B shows a normative data flow for CCRM/CCRP-based decoding. Given a coded bitstream (827), after inverse quantization (IQ) and inverse transform (IT) (850), luma residuals (854) and chroma residuals (852) are extracted. In unit 825B, the CCRM modeling parameters (e.g., alpha) are either derived explicitly based on decoded information or they are extracted from the bitstream via appropriate syntax parameters. In unit 865, the luma residuals (854) and the modeling parameters are applied to derive luma-modeled residuals (867) (e.g., alpha*Luma Residuals) which are added (870) to the chroma residuals (852) and chroma values of the intra predicted data (862C) to get the improved predicted output values for chroma (877). Similarly, the luma values of the intra predicted data (862L) are added (855) to the luma residuals (854) to derive the output values for luma (857).

In an embodiment, model parameters/coefficients (e.g., alpha) can be derived by solving the set of linear equations corresponding to neighbor luma and chroma residuals using LDL decomposition or a Gaussian elimination technique. In another embodiment, neighbor samples such as: left, right, top and bottom samples can be used in additional to the center samples as a five-parameter model, with or without non-linear and bias terms.

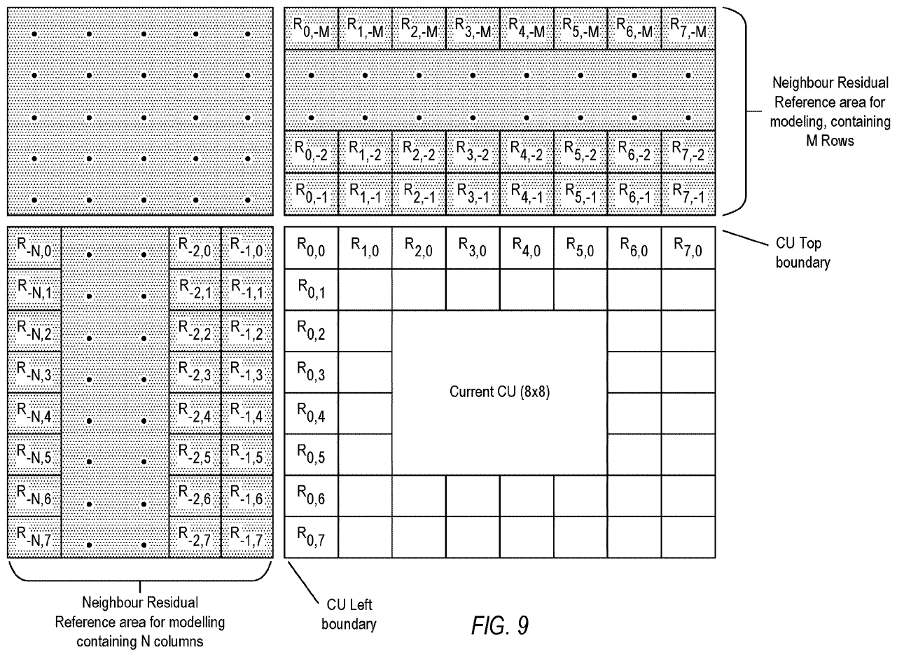

FIG. 9 depicts an example of the neighbor residual sample area containing M top rows and N left columns for chroma (e.g., M=2, N=2). The corresponding luma reference residual area is twice the size of chroma where it is down sampled/sub-sampled and used for modeling. To improve the model parameter accuracy, the continuity check is performed along the top and left boundary using the current luma residual samples and neighbor luma residual samples. For example, neighbor residuals from R(X,−1) to R(X,−M) are considered for modeling only when |(2*R(X,−1) −R(X,−2) −R(X,0))|<Th. Similarly, residuals from R(−1,Y) to R(−N,Y) are considered for modeling only when |(2*R(−1,Y) −R(−2,Y) −R(0,Y))|<Th, where Th denotes a threshold value to ensure continuity of luma residual across CU boundaries (e.g., Th=10<<(Bitdepth −8)).

In another embodiment, model parameters (e.g., alpha) may be explicitly signaled for certain CUs, but for other CUs, these parameters may be inferred from neighbor CUs whose prediction mode and residual properties are similar to the current CU. This new mode may be denoted as the CCRM_merge mode. For example, if the intra prediction mode for the current CU is a “Non-LM” mode (that is, chroma prediction is not using luma modeling modes like CCLM, CCCM or GLM), then only neighbor CUs with Non-LM intra prediction mode will be considered. Among these neighbor CUs, as an example, one may select the best neighbor CU by determining the least absolute difference between the means of the neighbor CU luma residual samples and the mean of the current luma residual samples. If the neighbor CU uses CCRM, then one may directly use the alpha model parameter from it, otherwise one may use its residuals to derive the model parameter. The pseudocode below provides an example use of the proposed CCRM_merge mode.

```
          if( CCRM_flag)
  {
  if(CCRM_merge_flag)
  {
    Infer the residual model parameters from a neighbor CU;
  }
  else
  {
    Derive the residual parameter model using signaled parameters
(e.g., via an alpha_idx parameter and a sign flag).
  }
}
```

In one embodiment, pre-defined model parameters can be used to reduce the signaling overhead of signaling the sign flag and the alpha_index values. Such pre-defined model parameters can also be signaled once at a header level (e.g., in a picture header or a slice header).

In another embodiment, the CCRM flag can be signaled for certain chroma intra prediction modes. For example, CCRM prediction mode (hence the CCRM flag) is allowed only for normal intra prediction modes like DC, Planar and Angular, and it is not allowed for cross component prediction modes such CCLM, CCCM, GLM, and the like.

In another embodiment, model parameters can be implicitly derived using the neighbor luma and chroma prediction data.

### CCCM Improvement

The basic idea is to introduce more non-linear elements (e.g., non-linear kernels) as input to the 7-tap convolutional filter which replaces the original weighted sum of the center luma sample (C) and four neighboring luma samples (N, S, W, E). The proposed non-linear CCCM (NL-CCCM) considers not only the intensity of reconstructed luma samples, but also the similarity between the neighboring and the center samples. The filter coefficient derivation process is not changed (Ref. [2]).

In one embodiment, one can use non-linear kernels to replace the weighted sum of the four neighboring samples. The predicted chroma value can be derived as:

$$predChromaVal = {c}_{0} C + {c}_{1} K ( N ) + {c}_{2} K ( S ) + {c}_{3} K ( E ) + {c}_{4} K ( W ) + {c}_{5} P + {c}_{6} B , \qquad ( 9 )$$

where K(−) is a non-linear kernel function taking into account the intensity or/and similarity to the center luma. For X ∈ in {N, S, E, W}, kernel functions K(X) can be defined as:

### 1) Distance:

$$a . \vert X - C \vert , ( e . g . , K ( X ) = \vert X - C \vert ) ;$$

b. |X-C|>th*maxVal?0: X, where th denotes a threshold.
For example, th=0.5. maxVal is defined as 2^{BitDepth}−1, minVal is 0, and midVal=2^{(BitDepth-1)},
Note: x?y:z denotes that if x is TRUE or not equal to 0, the output is the value of y; otherwise, the output is the value of z.

### 2) Square:

$$a . ( X * \vert X - C \vert + midVal ) ≫ bitDepth ,$$

$$b . [ {( X - C )}^{2} + midVal ] ≫ bitDepth$$

### 3) Square-Root:

$$a . sqrt ( X * \vert X - C \vert )$$

### 4) Gaussian:

$$a . X * exp [ - \vert X - C \vert / max Val ] ,$$

$$b . X * exp [ - {( X - C )}^{2} / max {Val}^{2} ]$$

### 5) Polynomial:

$$a . X * ( 1 - \vert X - C \vert / max Val ) ,$$

$$b . X * ( 1 - {\vert X - C \vert}^{2} / max {Val}^{2} ) ,$$

$$c . X * ( 1 - {\vert X - C \vert}^{3} / max {Val}^{3} ) , etc .$$

In another embodiment, one may use a higher-order polynomial (e.g., third order) of the center luma sample to replace the original non-linear term P=(C*C+midVal)>>bitDepth. Then, the predicted chroma value can be defined as:

$$predChromaVal = {c}_{0} C + {c}_{1} N + {c}_{2} S + {c}_{3} E + {c}_{4} W + {c}_{5} T + {c}_{6} B , \qquad ( 10 )$$

where the non-linear term T=(C³+midVal*maxVal)>>2*bitDepth.

In another embodiment, one may keep the non-linear term P=(C*C+midVal) >>bitDepth, while using a higher order polynomial (e.g., 3^{rd} order) of the center luma sample to replace one of the four neighboring samples which is the farthest from the center luma sample. The predicted chroma value can then be defined as:

$$predChromaVal = {c}_{0} C + {\sum }_{i = 1}^{3} {c}_{i} \cdot {X}_{i} + {c}_{4} T + {c}_{5} P + {c}_{6} B , \qquad ( 11 )$$

where the non-linear term T=(C³+midVal*maxVal)>>2*bitDepth, and Xᵢ∈{N, S, W, E} excluding the neighboring sample with a luma value being the furthest away from the luma value of the center (C) pixel. That is, if the difference in luma among all four neighbors is computed as

$${D}_{i} = \vert {X}_{iL} - {C}_{L} \vert , i = 1 to 4 ,$$

then, in equation (11), the summation with Xᵢ excludes the neighboring pixel for which Dᵢ is the largest.

In another embodiment, instead of replacing the original 7-tap filter, one can also treat the above modified NL-CCCM filters as additional intra prediction modes. Encoder side rate-distortion (RD) decision will be made based on the RD cost. When CCCM is enabled, a CU-level flag is signalled indicating whether to use the additional NL-CCCM mode. If NL-CCCM mode is used, a following filter index is signalled indicating which non-linear filter is applied to derive the final chroma prediction value. An example of syntax nl_cccm_flag can be used.

nl_cccm_flag equal to 1 indicates nonlinear CCCM is used. nl_cccm_flag equal to 0 indicates nonlinear CCCM is not used.

### REFERENCES

Each one of the references listed herein is incorporated by reference in its entirety. The term JVET refers to the Joint Video Experts Team of ITU-T SG 16 WP 3 and ISO/IEC JTC 1/SC 29.
[1]“Versatile Video Coding,” Rec. ITU-T H.266, August 2020.
[2] JVET-AB2025, “Algorithm description of Enhanced Compression Model 7 (ECM 7),” M. Coban et al., Mainz, Germany, October 2022.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to applying cross-component prediction tools in image and video coding, such as those described herein. The computer and/or IC may compute any of a variety of parameters or values that relate to applying cross-component prediction tools in image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to applying cross-component prediction tools in image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

Various aspects of the present disclosure may be appreciated from the following Enumerated Example Embodiments (EEEs):
EEE1. A method for video decoding inter-coded coding units, the method comprising:
   receiving a coded unit (CU) coded using inter-prediction mode;
   detecting via a first flag whether chroma prediction is enabled via linear-model luma-dependent chroma inter-prediction; and
   if the first flag indicates that chroma prediction is enabled via linear-model luma-dependent prediction, then
      reading a first syntax parameter indicating a specific luma-dependent chroma inter-prediction mode among two or more such modes;
      reading a second flag indicating whether a convolutional cross-component (CCCM) inter prediction model is used or not; and
      decoding chroma pixels of the coded unit based on the specific luma-dependent chroma inter-prediction mode and the second flag.
EEE2. The method of EEE1, wherein the first syntax parameter indicates one of a cross-component linear model (CCLM) or a gradient linear model (GLM), as used for chroma prediction for intra-coded CUs.
EEE3. The method of EEE2, wherein the first syntax parameter indicates using a fusion of the CCLM and CCCM models.
EEE4. The method of EEE3, wherein the fusion can be expressed as:

$${T}_{Ref} = w * {T}_{Inter} + ( 1 - w ) * {T}_{LMC} ,$$

where,
   T_{Ref} denotes a reference template region of chroma reconstruction strips bordering the coded unit;
   Tᵢₙₜₑᵣ denotes chroma prediction samples derived using inter prediction for the reference template region,
   T_{LMC} denotes chroma prediction samples derived using LMC prediction for the reference template region, and
   w denotes a weight in [0, 1].
EEE5. A method for encoding a video bitstream using cross-component residue modeling (CCRM), the method comprising:
   receiving input video pictures, each frame comprising luma and chroma pixels;
   for a region in an input video picture to be coded:
      accessing original chroma pixel values of the region;
      accessing predicted chroma pixel values and predicted residual luma pixel values of the region;
      generating chroma residual values by subtracting the predicted chroma pixel values from corresponding original chroma pixel values;
      deriving CCRM model parameters based on the predicted residual luma pixel values and the chroma residual values;
      applying the CCRM model parameters to the predicted residual luma pixel values to generate adjusted predicted residual luma pixel values;
      subtracting the adjusted predicted residual luma pixel values from the chroma residual values to generate adjusted chroma residual values; and
      generating a coded bitstream based at least on the adjusted chroma residual values.
EEE6. The method of EEE5, wherein the CCRM model parameters comprise alpha values, wherein computing the alpha values comprises computing

$$α = \frac{N * {\sum }_{1}^{N} {Res}_{C} [ i ] \times {Res}_{L}^{′} [ i ] - {\sum }_{1}^{N} {Res}_{C} [ i ] \times {\sum }_{1}^{N} {Res}_{L}^{′} [ i ]}{N \times {\sum }_{1}^{N} {Res}_{L}^{′} [ i ] \times {Res}_{L}^{′} [ i ] - {( {\sum }_{1}^{N} {Res}_{L}^{′} [ i ] )}^{2}} ,$$

where Res_{C} denotes predicted chroma residual values and Res′_{L} represents down-sampled predicted luma residual values surrounding the region, and N denotes the total number of neighboring samples.
EEE7. The method of EEE5 or EEE6, wherein the CCRM model parameters are signaled to a decoder together with the coded bitstream.
EEE8. A method for decoding a coded video bitstream using cross-component residue modeling (CCRM), the method comprising:
   receiving a coded bitstream comprising coded pictures, each coded picture comprising luma and chroma pixels;
   for a region in coded video picture:
      generating predicted residual luma pixel values and predicted residual chroma pixel values for the region based on the coded bitstream;
      accessing CCRM model parameters based on the predicted residual luma pixel values and the predicted residual chroma pixel values;
      applying the CCRM model parameters to the predicted residual luma pixel values to generate adjusted predicted residual luma pixel values;
      adding the adjusted predicted residual luma pixel values to the predicted residual chroma pixel values to generate adjusted chroma residual values; and
      adding the adjusted chroma residual values to inter-predicted chroma values for the region to generate output chroma pixel values for the region.
EEE9. The method of EEE8, wherein the CCRM model parameters comprise alpha values, wherein computing the alpha values comprises computing

$$α = \frac{N * {\sum }_{1}^{N} {Res}_{C} [ i ] \times {Res}_{L}^{′} [ i ] - {\sum }_{1}^{N} {Res}_{C} [ i ] \times {\sum }_{1}^{N} {Res}_{L}^{′} [ i ]}{N \times {\sum }_{1}^{N} {Res}_{L}^{′} [ i ] \times {Res}_{L}^{′} [ i ] - {( {\sum }_{1}^{N} {Res}_{L}^{′} [ i ] )}^{2}} ,$$

where Res_{C} denotes predicted chroma residual values and Res′_{L} represents down-sampled predicted luma residual values surrounding the region, and N denotes the total number of neighboring samples.
EEE10. The method of EEE8 or EEE9, wherein the CCRM model parameters are received together with the coded bitstream.
EEE11. The method of any one of EEE8 to EEE10, wherein the CCRM model parameters further comprise a CCRM-merge flag to indicate whether CCRM merge is enabled or not, wherein
   if CCRM is enabled, then
      if CCRM merge is enabled, then CCRM model parameters are inferred from a neighbor CU;
      else, if CCRM merge is not enabled, then CCRM model parameters are extracted from the bitstream.
EEE12. The method of any one of EEE8 to EEE11, wherein the CCRM model parameters comprise an index to an array of possible alpha values and a sign flag indicating whether a selected alpha value via the index is positive or negative.
EEE13. A method for chroma prediction using a convolutional cross-component (CCCM) prediction model, the model comprising predicting chroma values using a non-linear filter according to

$$predChromaVal = {c}_{0} C + {c}_{1} K ( N ) + {c}_{2} K ( S ) + {c}_{3} K ( E ) + {c}_{4} K ( W ) + {c}_{5} P + {c}_{6} B ,$$

wherein cᵢ, for i=0 to 6 denotes filter parameters, K(.) is a non-linear kernel function, and for a center luma sample (C), N, S, W, and E denote its north, south, west, and east neighbor pixel samples, P=(C*C+midVal)>>bitDepth, midVal=2^{(bitDepth-1)} and B is a fixed bias term between 0 and 2^{bitDepth}−1, wherein for a neighbor pixel X, K(X) comprises a function of distance:

$$K ( X ) = \vert X - C \vert or$$

$$K ( X ) = \vert X - C \vert > th * max Val ? 0 : X ,$$

where th denotes a threshold and maxVal=2^{bitDepth}−1.
EEE14. The method of claim 13, wherein K(X) comprises one of:

$$K ( X ) = ( X * \vert X - C \vert + midVal ) ≫ bitDepth ,$$

$$K ( X ) = [ {( X - C )}^{2} + midVal ] ≫ bitDepth ,$$

$$K ( X ) = sqrt ( X * \vert X - C \vert ) ,$$

$$K ( X ) = X * exp [ - \vert X - C \vert / maxVal ] ,$$

$$K ( X ) = X * exp [ - {( X - C )}^{2} / {maxVal}^{2} ]$$

$$K ( X ) = X * ( 1 - \vert X - C \vert / maxVal ) ,$$

$$K ( X ) = X * ( 1 - {\vert X - C \vert}^{2} / {maxVal}^{2} ) , or$$

$$K ( X ) = X * ( 1 - {\vert X - C \vert}^{3} / {maxVal}^{3} ) .$$

EEE15. A method for chroma prediction using a convolutional cross-component (CCCM) prediction model, the model comprising predicting chroma values using a non-linear filter according to

$$predChromaVal = {c}_{0} C + {c}_{1} N + {c}_{2} S + {c}_{3} E + {c}_{4} W + {c}_{5} T + {c}_{6} B ,$$

wherein cᵢ, for i=0 to 6 denotes filter parameters, and for a center luma sample (C), N, S, W, and E denote its north, south, west, and east neighbor pixel samples, and

$$T = ( {C}^{3} + {2}^{( bitDepth - 1 )} * ( {2}^{bitDepth} - 1 ) ≫ 2 * bitDepth . ,$$

and B is a fixed bias term between 0 and 2^{bitDepth}−1.
EEE16. A method for chroma prediction using a convolutional cross-component (CCCM) prediction model, the model comprising predicting chroma values using a non-linear filter according to

$$predChromaVal = {c}_{0} C + {\sum }_{i = 1}^{3} {c}_{i} \cdot {X}_{i} + {c}_{4} T + {c}_{5} P + {c}_{6} B ,$$

wherein cᵢ, for i=0 to 6 denotes filter parameters, B is a fixed bias term between 0 and 2^{bitDepth}−1,
for a center luma sample (C), Xᵢ is one of its east (E), north (N), west (W) and south (S) neighbors, wherein the neighbor for which its luma value differs the most from the luma value of the center luma sample (C) is excluded, and

$$T = ( {C}^{3} + {2}^{( bitDepth - 1 )} * ( {2}^{bitDepth} - 1 ) ≫ 2 * bitDepth .$$

EEE17. A tangible computer-readable storage medium having stored thereon computer-executable instructions for executing with one or more processors a method in accordance with any one of the methods recited in EEE1 to EEE16.
EEE18. An apparatus comprising a processor and configured to perform any one of the methods recited in EEE1 to EEE16.

### EQUIVALENTS, EXTENSIONS, ALTERNATIVES AND MISCELLANEOUS

Example embodiments that relate to applying cross-component prediction coding tools in image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for video decoding inter-coded coding units, the method comprising:
receiving a coded unit, CU, coded using an inter-prediction mode, wherein current luma blocks of the coded unit, CU, are predicted using inter-prediction to obtain current luma reconstructed samples;
detecting via a first flag whether chroma prediction is enabled using luma based modeling for chroma for inter CUs, wherein chroma blocks of the coded unit, CU, are predicted using the current luma reconstructed samples; and
if the first flag indicates that chroma prediction is enabled using luma based modeling for chroma for inter CUs, then
reading a first syntax parameter indicating a specific luma based modeling for chroma for inter CUs mode among two or more such modes;
reading a second flag indicating whether a convolutional cross-component, CCCM, model is used or not, wherein the convolutional cross-component, CCCM, model is derived using inter-prediction mode-derived luma and chroma prediction samples of the coded unit, CU; and
decoding chroma pixels of the coded unit based on the specific luma based modeling for chroma for inter CUs mode and the second flag.

2. The method of claim 1, wherein the first syntax parameter indicates one of a cross-component linear model (CCLM) or a gradient linear model (GLM), as used for chroma prediction for intra-coded CUs.

3. The method of claim 2, wherein the first syntax parameter indicates using a fusion of the CCLM and CCCM models.

4. The method of claim 3, wherein the fusion can be expressed as:
$${T}_{Ref} = w * {T}_{Inter} + ( 1 - w ) * {T}_{L M C} ,$$
where,
T_{Ref} denotes a reference template region of chroma reconstruction strips bordering the coded unit, Tᵢₙₜₑᵣ denotes chroma prediction samples derived using inter prediction for the reference template region, T_{LMC} denotes chroma prediction samples derived using LMC prediction for the reference template region, and w denotes a weight in [0, 1].

5. A method for encoding a video bitstream using cross-component residue modeling (CCRM), the method comprising:
receiving input video pictures, each frame comprising luma and chroma pixels;
for a region in an input video picture to be coded:
accessing original chroma pixel values of the region;
accessing predicted chroma pixel values and predicted residual luma pixel values of the region;
generating chroma residual values by subtracting the predicted chroma pixel values from corresponding original chroma pixel values;
deriving CCRM model parameters based on the predicted residual luma pixel values and the chroma residual values;
applying the CCRM model parameters to the predicted residual luma pixel values to generate adjusted predicted residual luma pixel values;
subtracting the adjusted predicted residual luma pixel values from the chroma residual values to generate adjusted chroma residual values; and
generating a coded bitstream based at least on the adjusted chroma residual values.

6. The method of claim 5, wherein the CCRM model parameters comprise alpha values, wherein computing the alpha values comprises computing
$$α = \frac{N * {\sum }_{1}^{N} {Res}_{C} [ i ] \times {Res}_{L}^{′} [ i ] - {\sum }_{1}^{N} {Rec}_{C} [ i ] \times {\sum }_{1}^{N} {Res}_{L}^{′} [ i ]}{N \times {\sum }_{1}^{N} {Res}_{L}^{′} [ i ] \times {Res}_{L}^{′} [ i ] - {( {\sum }_{1}^{N} {Res}_{L}^{′} [ i ] )}^{2}} ,$$
where Res_{C} denotes predicted chroma residual values and Res′_{L} represents down-sampled predicted luma residual values surrounding the region, and N denotes the total number of neighboring samples.

7. The method of claim 5, wherein the CCRM model parameters are signaled to a decoder together with the coded bitstream.

8. A method for decoding a coded video bitstream using cross-component residue modeling (CCRM), the method comprising:
receiving a coded bitstream comprising coded pictures, each coded picture comprising luma and chroma pixels;
for a region in coded video picture:
generating predicted residual luma pixel values and predicted residual chroma pixel values for the region based on the coded bitstream;
accessing CCRM model parameters based on the predicted residual luma pixel values and the predicted residual chroma pixel values;
applying the CCRM model parameters to the predicted residual luma pixel values to generate adjusted predicted residual luma pixel values;
adding the adjusted predicted residual luma pixel values to the predicted residual chroma pixel values to generate adjusted chroma residual values; and
adding the adjusted chroma residual values to inter-predicted chroma values for the region to generate output chroma pixel values for the region.

9. The method of claim 8, wherein the CCRM model parameters comprise alpha values, wherein computing the alpha values comprises computing
$$α = \frac{N * {\sum }_{1}^{N} {Res}_{C} [ i ] \times {Res}_{L}^{′} [ i ] - {\sum }_{1}^{N} {Rec}_{C} [ i ] \times {\sum }_{1}^{N} {Res}_{L}^{′} [ i ]}{N \times {\sum }_{1}^{N} {Res}_{L}^{′} [ i ] \times {Res}_{L}^{′} [ i ] - {( {\sum }_{1}^{N} {Res}_{L}^{′} [ i ] )}^{2}} ,$$
where Res_{C} denotes predicted chroma residual values and Res′_{L} represents down-sampled predicted luma residual values surrounding the region, and N denotes the total number of neighboring samples.

10. The method of claim 8, wherein the CCRM model parameters are received together with the coded bitstream.

11. The method of claim 8, wherein the CCRM model parameters further comprise a CCRM-merge flag to indicate whether CCRM merge is enabled or not, wherein
if CCRM is enabled, then
if CCRM merge is enabled, then CCRM model parameters are inferred from a neighbor CU;
else, if CCRM merge is not enabled, then CCRM model parameters are extracted from the bitstream.

12. The method of claim 8, wherein the CCRM model parameters comprise an index to an array of possible alpha values and a sign flag indicating whether a selected alpha value via the index is positive or negative.

13. A method for chroma prediction using a convolutional cross-component (CCCM) prediction model, the model comprising predicting chroma values using a non-linear filter according to
$$predChromaVal = {c}_{0} C + {c}_{1} K ( N ) + {c}_{2} K ( S ) + {c}_{3} K ( E ) + {c}_{4} K ( W ) + {c}_{5} P + {c}_{6} B ,$$
wherein cᵢ, for i=0 to 6 denotes filter parameters, K(.) is a non-linear kernel function, and for a center luma sample (C), N, S, W, and E denote its north, south, west, and east neighbor pixel samples, P=(C*C+midVal)>>bitDepth, midVal=2^{(bitDepth-1)} and B is a fixed bias term between 0 and 2^{bitDepth-1}, wherein for a neighbor pixel X, K(X) comprises a function of distance:
$$K ( X ) = \vert X - C \vert or$$
$$K ( X ) = \vert X - C \vert > th * maxVal ? 0 : X ,$$
where th denotes a threshold and maxVal=2^{bitDepth-1}.

14. The method of claim 13, wherein K(X) comprises one of:
$$K ( X ) = ( X * \vert X - C \vert + midVal ) ≫ bitDepth ,$$
$$K ( X ) = [ {( X - C )}^{2} + midVal ] ≫ bitDepth ,$$
$$K ( X ) = sqrt ( X * \vert X - C \vert ) ,$$
$$K ( X ) = X * exp [ - \vert X - C \vert / maxVal ] ,$$
$$K ( X ) = X * exp [ - {( X - C )}^{2} / {maxVal}^{2} ]$$
$$K ( X ) = X * ( 1 - \vert X - C \vert / maxVal ) ,$$
$$K ( X ) = X * ( 1 - {\vert X - C \vert}^{2} / {maxVal}^{2} ) , or$$
$$K ( X ) = X * ( 1 - {\vert X - C \vert}^{3} / {maxVal}^{3} ) .$$

15. A method for chroma prediction using a convolutional cross-component (CCCM) prediction model, the model comprising predicting chroma values using a non-linear filter according to
$$predChromaVal = {c}_{0} C + {c}_{1} N + {c}_{2} S + {c}_{3} E + {c}_{4} W + {c}_{5} T + {c}_{6} B ,$$
wherein cᵢ, for i=0 to 6 denotes filter parameters, and for a center luma sample (C), N, S, W, and E denote its north, south, west, and east neighbor pixel samples, and
$$T = ( {C}^{3} + {2}^{( bitDepth - 1 )} * ( {2}^{bitDepth} - 1 ) ≫ 2 * bitDepth . ,$$
and B is a fixed bias term between 0 and 2^{bitDepth-1}.

16. A method for chroma prediction using a convolutional cross-component (CCCM) prediction model, the model comprising predicting chroma values using a non-linear filter according to
$$predChromaVal = {c}_{0} C + {\sum }_{i = 1}^{3} {c}_{i} \cdot {X}_{i} + {c}_{4} T + {c}_{5} P + {c}_{6} B ,$$
wherein cᵢ, for i=0 to 6 denotes filter parameters, B is a fixed bias term between 0 and 2^{bitDepth-1}, for a center luma sample (C), Xᵢ is one of its east (E), north (N), west (W) and south (S) neighbors, wherein the neighbor for which its luma value differs the most from the luma value of the center luma sample (C) is excluded, and
$$T = ( {C}^{3} + {2}^{( bitDepth - 1 )} * ( {2}^{bitDepth} - 1 ) ≫ 2 * bitDepth .$$

17. A tangible computer-readable storage medium having stored thereon computer-executable instructions for executing with one or more processors a method in accordance with the methods recited in claims 1-46.

18. An apparatus comprising a processor and configured to perform the methods recited in claim 1.
